(19) United States
(12) Patent Application Publication
(10) Pub. No.: US 2008/0281907 A1
(43) Pub. Date: Nov. 13, 2008

(54) SYSTEM AND METHOD FOR GLOBALLY ISSUING AND VALIDATING ASSETS

(76) Inventor: Hilary VIEIRA, Mississauga (CA)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 12/116,787

(22) Filed: May 7, 2008

Related U.S. Application Data
(60) Provisional application No. 60/916,388, filed on May 7, 2007.

(51) Int. Cl. G06F 15/16; G06F 17/30

(52) U.S. Cl. 709/203; 707/9; 707/E17.001

(57) ABSTRACT

A system and method are provided for enabling two or more different entities to perform actions on assets including validating the assets and authorizing the assets. The assets may include financial instruments, real estate documents, bonds, share certificates, and/or traveler's cheques. Client terminals are coupled to a plurality of servers and global servers to receive updates regarding the status of the assets. The invention enables assets to be validated in real-time in order to reduce fraud, such as duplicate assets, false assets or a counterfeit asset.

### CROSS REFERENCE TO RELATED APPLICATION

This application claims priority to U.S. Provisional Application Ser. No. 60/916,388, filed May 7, 2007, the entire contents of which are incorporated herein by reference.

### STATEMENT REGARDING FEDERALLY SPONSORED RESEARCH OR DEVELOPMENT

N/A

### FIELD OF THE INVENTION

The invention relates to systems and methods of globally storing data that is associated with assets and/or enabling two or more unrelated entities to globally access the data that is associated with the assets. More particularly, the invention relates to enabling two or more unrelated entities to globally store and/or globally access data that is associated with the assets, including verifying the authenticity of the assets and/or obtaining ownership information associated with the assets, wherein the data is stored to and/or accessed from a storage device in real-time.

### BACKGROUND OF THE INVENTION

Known systems, such as financial systems, store data and enable a single entity, such as a financial institution and its affiliated branches, to access the data. For example, a financial institution or issuer may hold money in escrow and may issue financial instruments, such as traveler's cheques or other financial instruments, to an authorized purchaser to gain access to the money. When the purchaser desires to cash a traveler's cheque, the purchaser provides a payee with an executed traveler's cheque. The payee then submits the traveler's cheque to a local financial institution for cashing.

Prior to cashing the traveler's cheque, the local financial institution that receives the traveler's check typically attempts to validate the traveler's cheque to confirm the authenticity of the financial instrument. This may be performed to reduce fraud by seeking to discover counterfeit financial instruments. For high value transactions, the validation process may require manual intervention; including contacting the issuer via telephone and providing financial instrument numbers and/or other financial instrument data for authentication. In some cases, a financial institution may place a hold on cashing the financial instrument until the transaction is authorized by the issuer.

Known systems and methods are deficient at least because they require a manual process that includes agents of the local financial institution placing telephone calls to the issuer before the transaction is validated. In some instances, the purchaser also may be contacted to validate the value of the financial instrument. In view of the foregoing manual authentication steps, latency is introduced that increases the cost of using the financial instrument, at least for the financial institution and the payee.

Global transactions introduce additional complexities to releasing of funds. For example, with time differences and/or language differences between countries, the issuer may require validation of the financial instrument by physical delivery to the central bank of the receiving country. This may result in delays of days or weeks before the payee receives the expected funds.

An additional deficiency with existing systems and methods includes not being able to access data that is associated with the financial instrument in real-time (i.e., when the financial instrument is presented for honoring). Real-time data access enables discovery of duplicate, false or counterfeit financial instrument at the time that the financial instrument is presented for honoring.

Thus, existing systems and methods are deficient at least because they introduce delays in honoring financial instruments and/or they expose financial institutions to honoring fraudulent financial instruments. Various other drawbacks exist with these known systems and with other conventional systems.

### SUMMARY OF THE INVENTION

The invention provides a global server that may be accessed by two or more unaffiliated entities, including financial institutions, brokerage firms, real estate companies, and/or other entities, upon validation of the identity of each entity. According to one embodiment, entities may grant authority to specified users to access the centrally accessible global servers. The invention enables logging of transactions that are conducted by the specified users, based on transactional information, temporal information or other information. The logged transactions may be associated with the specified users and stored for subsequent use.

According to one embodiment, the global servers may validate specified users prior to granting access thereto. The invention may indirectly validate specified users by reading an identity card that is associated with a specified user or by performing other indirect validation of the specified users. Alternatively, the invention may perform direct validation of specified users by performing retinal scans, finger print scans, voice recognition comparisons or performing other direct validation of specified users.

According to one embodiment, the system includes a plurality of client terminals, a plurality of servers and a global server. The plurality of client terminals include an interface for obtaining data, including identity data and transactional data. The plurality of servers are associated with a plurality of institutions and communicate with corresponding client terminals. The plurality of servers include an identity module that receives identity data to identify users that access the client terminals and an access module that verifies the identity data and, upon verification, provides access to information within corresponding institutions that is associated with at least one of the identity data and the transactional data. Furthermore, the plurality of servers include a generating module that issues assets based on information that is associated with at least one of the identity data and the transactional data for corresponding institutions and a retrieving module that receives data, including data that identifies previously generated assets, data that identifies institutions that are associated with the previously generated assets, or both.

The global server communicates with the plurality of servers, the plurality of client terminals, or a combination thereof and includes a global identify module that receives global identity data from the plurality of servers, the plurality of clients, or both, to identify the users that access the client terminals, the institutions, or both. A gatekeeper module is provided to verify the global identity data and, upon verification, provides access to information in the global server that is associated with the global identify data. A storage module stores data received from the plurality of servers and the plurality of client terminals, including at least one of data identifying issued assets and data identifying previously generated assets and a validation module validates at least one of pre-selected issued assets and pre-selected previously generated assets that are associated with the global identity data.

The invention provides global servers having encryption schemes that control access to data that is stored within the global servers. The global servers may include encryption schemes that limit data exchange to pre-selected entities. According to one embodiment, the global server may be responsive to change the encryption format for individual entities. According to another embodiment, the global server may be responsive to change the encryption format that is used globally by all entities. The invention may grant each validated entity access to change their corresponding encryption format. According to one embodiment, an administrator having administrator rights over the global server may change the global encryption format.

According to one embodiment of the invention, the global server may store data that corresponds to asset identification information, such as asset identification numbers, asset issuer information, and/or asset expiration information, among other data. The global server may store data that corresponds to issuing institution identifiers, such as issuer names, issuer addresses and/or issuer account information, among other data. According to one embodiment, the global server may store contact information for entities, users and/or others, to enable performance of actions, such as validating the entities and/or the users, if needed. The global server may include hard disks, tape drives, ROM disks, such as a CD-ROM or DVD-ROM disk, and/or any other storage device.

For tracking purposes or other purposes, the assets may be associated with identifiers. According to one embodiment, the identifiers may be affixed to the assets. According to one embodiment, the identifiers may include secure identifying marks, bar codes, radio frequency identification tags, holographic marks, embedded chips or other identifiers. According to one embodiment, the identifiers may be machine readable to facilitate real-time validation and/or authorization of the assets. The identifiers may be readable by devices that are remotely located, including automatic teller machines (ATM), retail point-of-sale registers and/or other remotely located devices.

The invention provides a method of processing assets by associating an asset with identifying data and associating the identifying data with a first entity. A record is generated to include the asset, the identifying data, and associated information, including the first entity information. A first entity may request access to a global server to store a record of the asset, the identifying data and the associated information at the global server. The record may be updated periodically. A second entity may request access to the global server and may be authenticated. The second entity may be granted access to the global server and the record. The second entity may request a status inquiry of the record and may be provided with a real-time status of the record.

The invention provides numerous advantages over and avoids many drawbacks of conventional systems. These and other objects, features, and advantages of the invention will be apparent through the detailed description of the embodiments and the drawings attached hereto. It is also to be understood that both the foregoing general description and the following detailed description are exemplary and not restrictive of the scope of the invention. Numerous other objects, features, and advantages of the invention should become apparent upon a reading of the following detailed description when taken in conjunction with the accompanying drawings, a brief description of which is included below.

### BRIEF DESCRIPTION OF THE DRAWINGS

A more complete understanding of the present invention, and the attendant advantages and features thereof, will be more readily understood by reference to the following detailed description when considered in conjunction with the accompanying drawings, wherein:

FIG. 1 illustrates a system diagram according to one embodiment of the invention; and

FIG. 2 illustrates a flow chart for processing assets according to one embodiment of the invention.

### DETAILED DESCRIPTION OF THE INVENTION

The invention provides systems and methods of employing global servers to store data, including confidential data that is associated with assets, including financial instruments, real estate documents, bonds, share certificates, and/or traveler's cheques, among other assets. The invention further provides systems and methods of employing global servers that enable two or more unaffiliated financial institutions to access data associated with the assets in substantially real-time. The invention further provides systems and methods of employing global servers that enable two or more financial institutions to perform actions on the assets, including validating the assets, authorizing the assets, and/or performing other actions on the assets.

By contrast, existing financial systems employ closed architectures that enable only a single financial institution and its affiliated branches to access data associated with a financial instrument. Furthermore, existing systems that employ closed architectures are not able to detect whether the asset that is issued by a different system having a separate closed architecture is a fraudulent asset, such as a duplicate asset, a false asset or a counterfeit asset.

The invention provides a global server that may be accessed by two or more unaffiliated entities, including financial institutions, brokerage firms, real estate companies, and/or other entities, upon validation of the identity of each entity. According to one embodiment, entities may grant authority to specified users to access the centrally accessible global servers. The invention enables logging of transactions that are conducted by the specified users, based on transactional information, temporal information or other information. The logged transactions may be associated with the specified users and stored for subsequent use.

According to one embodiment, the global servers may validate specified users prior to granting access thereto. The invention may indirectly validate specified users by reading an identity card that is associated with a specified user or by performing other indirect validation of the specified users. Alternatively, the invention may perform direct validation of specified users by performing retinal scans, finger print scans, voice recognition comparisons or performing other direct validation of specified users.

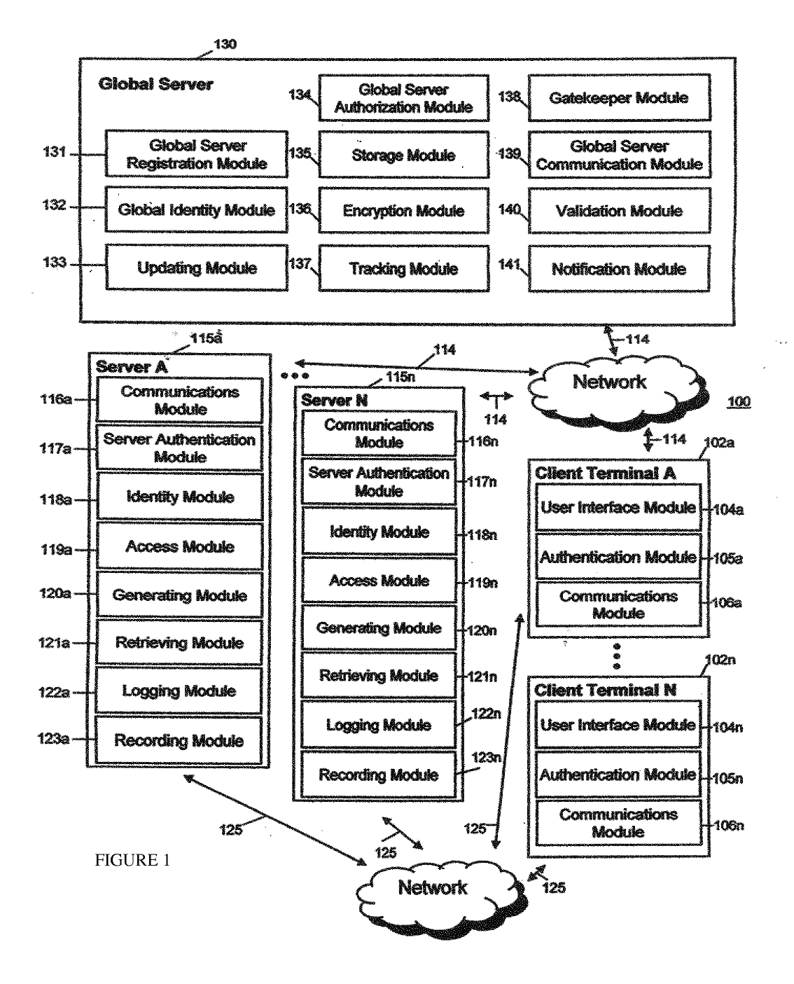

Referring to the drawing figures in which like reference designators refer to like elements, FIG. 1 illustrates system architecture 100 according to one embodiment of the invention. The client terminal devices 102a-102n (hereinafter client terminal devices 102), one or more servers 115a-115n (hereinafter servers 115), and one or more global servers 130 may be connected via wired media, wireless media, or a combination thereof. According to one embodiment of the invention, the client terminal devices 102, the servers 115, and the global server 130 may reside in one or more networks, such as an internet, an intranet, or a combination thereof.

According to one embodiment of the invention, the client terminal devices 102 may be affiliated with, or otherwise may be identified with, one or more institutions or entities A, B, . . . N, etc. The servers 115 may be affiliated with, or otherwise may be identified with, one or more of entities A, B, . . . N, etc., wherein the server 115a may be affiliated, or otherwise may be identified with entity A and the server 115n may be affiliated, or otherwise may be identified with entity N. The global servers 130 may communicate with one or more client terminal devices 102 and/or one or more servers 115 that are affiliated with, or otherwise identified with, one or more entities A, B, . . . N, etc. According to one embodiment of the invention, data communicated between the client terminal devices 102, the servers 115, and the global servers 130 may include unique identifiers that associate the data with the one or more entities and/or the corresponding devices, among other sources.

According to one embodiment of the invention, the client terminal devices 102 may include any number of different types of client terminal devices, including personal computers, laptops, smart terminals, personal digital assistants (PDAs), cell phones, portable processing devices that combine the functionality of one or more of the foregoing, and/or other client terminal devices. The client terminal devices 102 may include scanners that read the identifiers associated with the assets. According to one embodiment of the invention, the scanners may include optical scanners, radio frequency scanners and/or other scanners.

According to another embodiment of the invention, the client terminal devices 102 may include several components, including processors, random access memory (RAM), universal serial bus (USB) interfaces, scanners, telephone interfaces, microphones, speakers, a stylus, a computer mouse, a wide area network interface, local area network interfaces, hard disk drives, wireless communication interfaces, DVD/CD readers/burners, a keyboard, a flat touch-screen display, a computer display, and/or other components. According to yet another embodiment of the invention, client terminal devices 102 may include, or be modified to include, software that may operate to provide data gathering and/or data exchange functionality.

The servers 115 and/or the global servers 130 may include any number of different types of servers, such as personal computers, laptops, smart terminals, and/or other servers. According to another embodiment of the invention, the servers 115 and/or the global servers 130 may include several components, including processors, random access memory (RAM), universal serial bus (USB) interfaces, telephone interfaces, microphones, speakers, a stylus, a computer mouse, a wide area network interface, local area network interfaces, hard disk drives, wireless communication interfaces, a keyboard, a flat touch-screen display, a computer display, and/or other components.

According to one embodiment of the invention, the client terminal devices 102, the servers 115, and/or the global servers 130 may include several modules. The modular construction facilitates adding, deleting, updating and/or amending modules therein and/or features within modules. One skilled in the art will readily appreciate that the invention may be implemented using individual modules, a single module that incorporates the features of two or more separately described modules, individual software programs, and/or a single software program.

The client terminal devices 102 may include, or be modified to include, various modules, including a user interface module 104, an authentication module 105, a communications module 106 and/or other modules. It should be readily understood that a greater number or lesser number of modules may be used.

According to one embodiment of the invention, the client terminal devices 102 may communicate with other devices through software applications, for example. The user interface modules 104 may support several interfaces including display screens, voice recognition systems, speakers, microphones, input buttons, and/or other interfaces. The user interface modules 104 may display a browser application on a user interface that is associated with the client terminal device 102. According to one embodiment, select functions may be implemented through the client terminal device 102 by positioning an indicator over selected icons and manipulating an input receiving device, such as a mouse, a keyboard, or other input receiving device. According to another embodiment of the invention, select functions may be implemented through the client terminal device 102 using a voice recognition system to enable hands-free operation. The client terminal devices 102 may include a touch-sensitive display screen that is combined with an audio input device, such as a voice recognition system.

With regard to user authentication, the authentication modules 105 may employ one of several different authentication schemes, as would be appreciated by those skilled in the art. According to one embodiment of the invention, the authentication modules 105 may prompt users to input alphanumeric code or other identifying information. According to another embodiment of the invention, the authentication modules 105 may prompt users to provide biometric information (i.e., a thumbprint through a fingerprint scanner) or other suitable identifying information. If the user is not identified, then the user may be invited to resubmit the requested identification information or to take other action.

The client terminal devices 102 may include communication modules 106 for enabling the client terminal devices 102 to communicate with systems, including other client terminal devices, the servers 115, the global servers 130 and/or other systems. The client terminal devices 102 may communicate through communications media 114/125 such as, for example, any wired and/or wireless media. According to one embodiment, communications that occur between the client terminal devices 102, the global servers 130 and the servers 115 may occur substantially in real-time, when the devices are connected to the network. The communications module 106 may communicate with the servers 115 and the global servers 130 to exchange data, wherein the data exchange may occur with or without user awareness of the data exchange.

According to an alternative embodiment of the invention, communications may be delayed for an amount of time if, for example, one or more of the client terminal devices 102, the servers 115, and/or the global servers 130 are not connected to the network. Any requests that are submitted while the client terminal devices 102, the servers 115 and/or the global servers 130 are not connected to the network may be stored and propagated from/to the offline client terminal devices 102, the servers 115 and/or the global servers 130 when the target client terminal devices 102, the servers 115 and/or the global servers 130 are re-connected to the network. One of ordinary skill in the art will appreciate that communications may be conducted in various ways and among various devices.

According to one embodiment of the invention, the servers 115 may be associated with financial institutions, brokers and/or other institutions. The client terminal devices 102 may include applications that identify the client terminal devices 102 as being affiliated with the financial institutions, brokers and/or other institutions. According to one embodiment, data may be captured at the client terminal devices 102 and may be forwarded to the servers 115 that are affiliated with the financial institutions, brokers and/or other institutions. The servers 115 may store the data that is captured from the affiliated client terminal devices 102.

According to one embodiment, the servers 115 may include, or be modified to include, various modules, including a communications module 116, a server authentication module 117, an identity module 118, an access module 119, a generating module 120, a retrieving module 121, a logging module 122, a recording module 123 and/or other modules. It should be readily understood that the invention may be implemented with a greater number or lesser number of modules.

According to one embodiment, the communications module 116 may operate to provide data gathering and data exchange functionality. The communications module 116 may communicate with the client terminals 102, the global servers 130 and/or other systems to initiate data forwarding and/or data receiving. The communications module 116 may receive user authentication information and/or identification information to perform various functions. The communications module 116 may operate to coordinate communications between the client terminal devices 102, the servers 115 and/or the global servers 130. The plurality of servers 115 may forward data to the global servers 130 that is associated with various financial institutions, brokers and/or other institutions.

According to one embodiment of the invention, the server authentication module 117 may receive authentication information that is entered into a corresponding client terminal device 102 through the authentication modules 105. The server authentication module 117 may compare the authentication information with pre-existing records and operate as a gatekeeper to the system 100. If a determination is made that the user is a registered user, the server authentication module 117 may attempt to authenticate the registered user by matching the entered authentication information with access information that preexists on the servers 115. If the user is not authenticated, then the user may be invited to resubmit the requested authentication information or take other action. If the user is authenticated, then the servers 115 may perform other processing. For example, the client terminal devices 102 may be permitted to submit information requests to the servers 115, receive information from the servers 115, and/or receive information from other authenticated client terminal devices, among performing other actions.

If the user is connected to a network at login, a determination may be made regarding whether or not the user has previously registered. If not, then the server authentication module 117 may provide users with a registration user interface to prompt the user to register. Requested registration information may include, for example, user names, corporate names, addresses, identification numbers, telephone numbers, and/or other registration information. Following receipt of the registration information and after performing a verification process, the server authentication module 117 may add the user to the list of authorized users.

After the user is authenticated, the identity module 118 may access corresponding user identity data for each authenticated user. According to one embodiment, the user identity data may be stored at the server 115. The access module 119 verifies the user identity data and assigns access rights to authorized users based on the user identity data. The access rights may be implemented using rules that define how authenticated users may access information within the corresponding servers 115. According to one embodiment, the access module 119 may grant access rights to data within the servers 115 based on criteria, including identity data, transactional code information, employment information, and threshold value limits, among other criteria. The access module 119 also may grant credentials to authorized users for accessing the global servers 130.

According to one embodiment, after the identity of authorized users is verified, the authorized users may be directed to the generating module 120 associated with the corresponding server 115. According to one embodiment, the generating module 120 may be accessed using web-based applications. The user interface may include a list of assets that the user is authorized to issue and/or that the customer is qualified to receive. The generating module 120 enables the authorized users to issue assets, including financial instruments, real estate documents, bonds, share certificates, and/or traveler's cheques, among other assets.

Asset identification information may be generated upon creation of assets. Asset identification information may include asset identification numbers, asset issuer information, and asset expiration information, among other information. The server 115 may associate issuing institution information with the generated assets, including issuing institution identifiers, issuer names, issuer addresses and/or issuer account information, among other data. According to one embodiment, the server 115 may associate contact information with the generated assets, including entity contact information, authorized user contact information, customer contact information and/or other contact information, to facilitate validation or performance of other actions, if needed. The server 115 may include hard disks, tape drives, ROM disks, such as a CD-ROM or DVD-ROM disk, and/or any other storage device.

According to one embodiment, the invention contemplates a recording module 123 that applies identifiers to assets. The identifiers may be applied physically or electronically to images, for example. The identifiers may include secure identifying marks, bar codes, radio frequency identification tags, holographic marks, embedded chips or other identifiers. The identifiers may be randomly generated or may correspond to information that is available for the assets. The identifiers may be machine readable to facilitate real-time validation and/or authorization of the assets. The identifiers may be readable by devices that are remotely located, including automatic teller machines (ATM), retail point-of-sale registers and/or other remotely located devices. The identifiers may be used for tracking purposes or other purposes.

A retrieving module 121 may be provided that gathers identifying data from previously generated assets. Identifying data readers may include bar code readers, radio frequency identification tag readers, embedded chip readers or other readers. The readers may operate in real-time communication with the system to enable real-time validation and/or authorization of the assets. The reading devices may be remotely located and may include automatic teller machines (ATM), retail point-of-sale registers and/or other remotely located reading devices.

The readers may extract asset identification information, including asset identification numbers, asset issuer information, and asset expiration information, among other information. The system may associate issuing institution information with the generated assets, including issuing institution identifiers, issuer names, issuer addresses and/or issuer account information, among other data. According to one embodiment, the system may associate contact information with the generated assets, including entity contact information, authorized user contact information, customer contact information and/or other contact information, to facilitate validation or performance of other actions, if needed.

The logging module 122 may be provided to associate the user identity data with asset identification information, transactional information, temporal information or other information. The logged transactions may be associated with the corresponding authorized users and stored for subsequent use.

According to one embodiment of the invention, the global servers 130 may include, or be modified to include, a global server registration module 131, a global identity module 132, an updating module 133, a global server authorization module 134, a storage module 135, an encryption module 136, a tracking module 137, a gatekeeper module 138, a global server communication module 139, a validation module 140 and a notification module 141.

The global server registration module 131 communicates with the servers 115 over the network 114 to initiate a connection. The global server registration module 131 and the servers 115 may exchange pre-determined information to establish the connection. According to one embodiment, a security protocol may be used to secure the communication. For example, a token may be transmitted over a secure socket layer (SSL) connection that is encrypted with triple data encryption standard (DES). The global server 130 may verify the request with a call-back that provides reciprocal verification. According to another embodiment of the invention, additional security may be provided by limiting a range of recognized IP addresses.

Upon successful registration, the global server 130 may facilitate data exchange with one or more servers 115. The data exchange may occur in real-time and may be performed in substantially real-time. According to one embodiment, the global server registration module 131 may receive identifier information associated with the assets, the authorized users and/or the customers. According to one embodiment, the global server registration module 131 may receive asset identifier information from corresponding servers 115, including asset identification numbers, asset issuer information, and asset expiration information, among other information. The asset identifier information may be provided as bar code information, radio frequency identification tag information, embedded chip information or other identifier information.

The global server registration module 131 may receive asset identification information, including asset identification numbers, asset issuer information, and asset expiration information, among other information. The global server registration module 131 also may receive issuing institution information, including issuing institution identifiers, issuer names, issuer addresses and/or issuer account information, among other data. According to one embodiment, contact information may be associated with the generated assets, including entity contact information, authorized user contact information, customer contact information and/or other contact information, to facilitate validation or performance of other actions, if needed.

The information from the various servers 115 may be encrypted to limit access to authorized users. The encryption module 136 may include encryption schemes that control access to data stored within the global servers 130. The encryption module 136 may control data exchange between pre-selected entities. The encryption format for individual entities may be changed by the encryption module 136. Additionally, the encryption module 136 may be responsive to change the encryption format used globally by all entities. According to one embodiment, each validated entity may be granted access to change their corresponding encryption format. The encryption module 136 may enable an administrator having administrator rights over the global server to change the global encryption format.

The global server authorization module 134 may employ one of several different authorization schemes, as would be appreciated by those skilled in the art. The global server authorization module 134 may scan received data for identifying information. If identifying information is not detected, then the entity seeking to access the global server 130 may be denied access.

The global identity module 132 receives identity data from the servers 115, the plurality of clients 102 and/or the authorized users and determines the originating entity, the originating client terminals 102 and/or the authorized user that accessed the client terminals 102. The gatekeeper module 138 communicates with the global identity module 132 and attempts to verify the global identity data. Upon verifying the global identity data, the gatekeeper module 138 may grant access to information associated with the global identity data. Upon verifying asset identifying data, the validation module 140 may access selected assets associated with the global identity data and provide status information including whether or not the asset is validated, not validated, authorized and/or not authorized, among providing other status information. The validation module 140 also may validate and/or authenticate assets that are received from the client terminal devices 102 and/or the server 115.

A storage module 135 may be provided to store data received from the servers 115 and/or the plurality of clients 102, including data identifying previously generated assets, issued assets, redeemed assets, and/or assets created by unauthorized users, among other data. According to one embodiment, data within the storage module 135 may be searched using a variety of techniques. For example, structured query language (SQL) may be used to search using SQL statements that perform tasks on the storage module 135, such as retrieving data. The search for data retrieved from the storage module 135 may be limited to data that corresponds to the selected entities.

According to an alternative embodiment, a minimal amount of the data retrieved from the servers 115 and/or client terminals 102 may be stored at the global server 130. In other words, the global servers 130 may perform data gathering and may thereafter purge all or portions of the retrieved data. As a result, the invention may minimize security risks associated with exposing any confidential data to unauthorized parties at the global servers 130. According to another embodiment, the retrieved data may be stored at the storage module 135 for a predetermined amount of time before being purged. According to yet another embodiment of the invention, public record information, non-confidential retrieved data, and/or tracking information, such as activity log files associated with an entity, may be stored at the global server 130.

According to one embodiment, the global server communication module 139 may be provided to initiate forwarding of data retrieved from the storage module 135. The data retrieved from the storage module 135 may be forwarded to the servers 115 and/or client terminals 102 at a time when the data is obtained, in essentially real-time, or at a time thereafter. According to another embodiment, the data retrieved from the storage module 135 may be stored at the global server 130 and may be distributed to servers 115 and/or client terminals 102 after occurrence of pre-determined criteria, including passage of a pre-determined amount of time, accumulation of a pre-determined amount of data, occurrence of an event and/or other predetermined criteria.

The global server communication module 139 may communicate via communications media 114 and 125 such as, for example, any wired and/or wireless media. Communications between the client terminals 102, the servers 115 and the global server 130 may occur substantially in real-time, when the devices are coupled to the network. The global server communication module 139 may communicate with the client terminals 102 and/or server 115 to exchange data, wherein the data exchange may occur with or without user awareness of the data exchange.

The global server 130 may include an updating module 133 that initiates updates of the data retrieved from the servers 115 and/or client terminals 102. According to one embodiment, logic may provide rules that define how data is updated from the servers 115 and/or client terminals 102. The retrieved data may be updated based on criteria, such as entity information, issuer information, date, and/or other criteria. The updated information may be used to provide real-time information associated with the assets.

The invention may enable tracking of data communication across a network. For example, the tracking module 137 may associate an internet protocol (IP) address, or other identifying information, of the client terminal 102 with data that is provided by the global server 130. According to one embodiment of the invention, the data tracking features may be employed to generate usage logs. According to one embodiment of the invention, usage logs may provide transparency for transactions. For example, the tracking module 137 may provide data identifying requestor information, client terminal information, data elements that were obtained from the global server 130, and other identifying data. According to one embodiment of the invention, the identifying data may be provided in real-time. According to one embodiment, the tracking module 137 may be operated on a subscription basis. In other words, the tracking module 137 may be remotely activated and remotely deactivated based on payment of a subscription fee or other fee.

The tracking module 137 may include a monitoring feature that monitors communication between the servers 115 and the global server 130. According to one embodiment, the tracking module 137 may monitor data packets that traverse communications lines 114, wherein the data packets may include identification markers. The extracted information may include data requests that correspond to selected entities that are associated with the servers 115.

The global server 130 may include a notification module 141 that generates notifications and/or alerts. According to one embodiment, the notification module 141 may generate and forward notifications to client terminal devices 102 and/or to the servers 115 upon receipt of information by the global servers 130. For example, the notifications may include items, such as a listing of data elements that were requested from global server 130, a listing of data elements that were retrieved from servers 115, an identity of the requester, a suspected fraud notification, and/or other items.

According to another embodiment of the invention, the selected entities may be actively monitored by placing the selected entities on a watch list. According to one embodiment of the invention, the selected entities may be monitored based on features, such as data attributes, patterns and/or other features. According to one embodiment of the invention, the notification module 141 may alert servers 115 when information in storage module 135 is updated for selected entities that are placed on the watch list. Upon receipt of the alert, the server 115 may perform actions, such as notifying a predetermined client device 102 that is associated with a department, such a fraud department or other department. According to another embodiment of the invention, the client devices 102 may be notified of suspicious activity. According to one embodiment of the invention, the notifications and/or the alerts may be communicated over wired or wireless media 114, 125. The notifications and/or alerts may be generated based on various triggers.

According to one embodiment of the invention, the global server 130 may generate the notifications and/or alerts in real-time. The generated notifications and/or alerts may be delivered in real-time. Alternatively, the notifications and/or alerts may be delivered after a pre-determined delay. The notifications and/or alerts may be delivered using known communication techniques including electronic mail, mobile telephones, telephone messages, text messages, instant messages, and other communication techniques. The notifications and/or alerts may be delivered through the client terminals 102, the servers 115, or other communication devices including cell phones, personal digital assistants (PDAs) that are linked to the client terminal devices 102 and/or the servers 115.

FIG. 1 is provided for illustrative purposes only and should not be considered limitations of the invention. Other configurations will be appreciated by those skilled in the art and are intended to be encompassed by the invention.

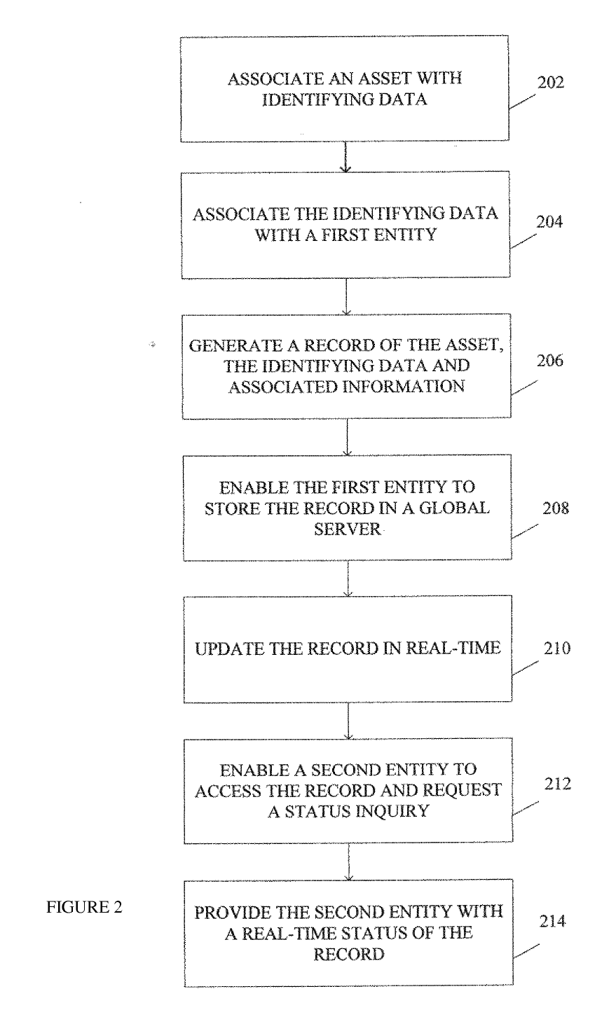

FIG. 2 is a flow chart of a process of globally storing data that is associated with assets and enabling two or more unrelated entities to access the stored data. An asset is associated with identifying data (step 202). In step 204, the identifying data is associated with a first entity. In step 206, a record is generated of the asset, the identifying data, and associated information, including the first entity information. According to one embodiment, the first entity may request access to a global server. The record of the asset, the identifying data and the associated information is stored at the global server (step 208). The record is updated in real-time (step 210). According to one embodiment, a second entity may request access to the global server and may be authenticated. The second entity may access the record and, in step 212, the second entity may request a status inquiry of the record. In step 214, a real-time status of the record is provided to the second entity.

While the preferred forms of the invention have been disclosed, it will be apparent to those skilled in the art that various changes and modifications may be made that will achieve some of the advantages of the invention without departing from the spirit and scope of the invention. It will be apparent to those reasonably skilled in the art that other components performing the same function may be suitably substituted. Further, the methods of the invention may be achieved in either all software implementations, using the appropriate processor instructions, or in hybrid implementations that utilize a combination of hardware logic and software logic to achieve the same results. Therefore, the scope of the invention is to be determined solely by the appended claims.

I claim:

1. A system for processing assets, the system comprising:
a plurality of servers that are associated with a plurality of institutions; and
a global server that is adapted to communicate with at least one of the plurality of servers, the global server comprising:
a global identify module that receives global identity data from the plurality of servers to identify at least users and the institutions;
a gatekeeper module that verifies the global identity data and, upon verification, provides access to information in the global server that is associated with the global identify data;
a storage module that stores data received from the plurality of servers, including at least one of data identifying issued assets and data identifying previously generated assets; and
a validation module that validates at least one of pre-selected issued assets and pre-selected previously generated assets that are associated with the global identity data.

2. The system according to claim 1, wherein the plurality of servers comprise:
an identity module that receives identity data to identify users;
an access module that verifies the identity data and, upon verification, provides access to information within corresponding institutions that is associated with at least one of the identity data and the transactional data;
a generating module that issues assets based on information that is associated with at least one of the identity data and the transactional data for corresponding institutions; and
a retrieving module that receives data, including at least one of data that identifies previously generated assets and data that identifies institutions that are associated with the previously generated assets.

3. The system according to claim 1, wherein the plurality of servers are adapted to obtain at least one of document identifying data for the assets, issuing institution data for the assets, and issuer data for the assets.

4. The system according to claim 2, wherein the plurality of servers further comprise a logging module that logs transactions performed on the corresponding server and associates the transactions with the identify data.

5. The system according to claim 1, wherein the validation module validates, in substantially real-time, the at least pre-selected issued assets and the pre-selected previously generated assets.

6. The system according to claim 1, wherein the global server further comprises a notification module that generates an alert providing the validation status of at least one of the pre-selected issued assets and the pre-selected previously generated assets.

7. The system according to claim 1, wherein the global server further comprises a notification module that generates an alert in real-time providing the validation status of at least one of the pre-selected issued assets and the pre-selected previously generated assets.

8. A system for processing assets that uses a plurality of client terminals to obtain at least identity data and transactional data and a plurality of servers that are associated with a plurality of institutions to communicate with corresponding client terminals, the system comprising:
a global server that is adapted to communicate with at least one of the plurality of servers and the plurality of client terminals, the global server comprising:
a global identify module that receives global identity data from at least the plurality of servers and the plurality of clients, to identify at least the users that access the client terminals and the institutions;
a gatekeeper module that verifies the global identity data and, upon verification, provides access to information in the global server that is associated with the global identify data;
a storage module that stores data received from the plurality of servers and the plurality of client terminals, including at least one of data identifying issued assets and data identifying previously generated assets; and
a validation module that validates at least one of pre-selected issued assets and pre-selected previously generated assets that are associated with the global identity data.

9. The system according to claim 8, wherein the plurality of servers comprise:
an identity module that receives identity data to identify users that access the client terminals;
an access module that verifies the identity data and, upon verification, provides access to information within corresponding institutions that is associated with at least one of the identity data and the transactional data;
a generating module that issues assets based on information that is associated with at least one of the identity data and the transactional data for corresponding institutions; and
a retrieving module that receives data, including at least one of data that identifies previously generated assets and data that identifies institutions that are associated with the previously generated assets.

10. The system according to claim 8, wherein the client terminals receive the transactional data and generate at least one of document identifying data for the assets, issuing institution data for the assets, and issuer data for the assets.

11. The system according to claim 9, wherein the plurality of servers further comprise a logging module that logs transactions that are performed on the corresponding server and associates the transactions with the identify data.

12. The system according to claim 8, wherein the validation module validates, in substantially real-time, the at least pre-selected issued assets and the pre-selected previously generated assets.

13. The system according to claim 9, wherein the client terminals are adapted to validate at least one of the pre-selected issued assets and the pre-selected previously generated assets directly with the global server.

14. The system according to claim 8, wherein the global server further comprises a notification module that generates an alert providing the validation status of at least one of the pre-selected issued assets and the pre-selected previously generated assets.

15. The system according to claim 8, wherein the global server further comprises a notification module that generates an alert in real-time to provide the validation status of at least one of the pre-selected issued assets and the pre-selected previously generated assets.

16. The system according to claim 8, wherein the global server further comprises a tracking module that records events associated with the at least pre-selected issued assets and the pre-selected previously generated assets.

17. The system according to claim 16, wherein the tracking module is adapted to record the events in chronological time order.

18. A method of processing assets to enable two different entities to access data, comprising:
associating an asset with identifying data;
associating the identifying data with a first entity;
generating a record that includes at least the asset, the identifying data, and the first entity;
storing the record;
enabling a second entity to access the record;
enabling the second entity to request a status inquiry of the record; and
providing a status of the record to the second entity.

19. The method according to claim 18, wherein the record is updated in real-time.

20. The method according to claim 18, wherein the assets include at least one of financial instruments, real estate documents, bonds, share certificates, and traveler's cheques.
